(19) United States
(12) Patent Application Publication
(10) Pub. No.: US 2004/0125385 A1
(43) Pub. Date: Jul. 1, 2004

(54) Estimating a guarantee time

(76) Inventors: Douglas J. Mellor, Meridian, ID (US); Dana A. Jacobsen, Boise, ID (US); Richard M. Dow, Laramie, WY (US)

Correspondence Address: HEWLETT-PACKARD COMPANY, Intellectual Property Administration, P.O. Box 272400, Fort Collins, CO, 80527-2400, US

(21) Appl. No.: 10/331,834

(22) Filed: Dec. 30, 2002

(51) Int. Cl. G06F 15/00

(52) U.S. Cl. 358/1.1; 358/1.15

(57) ABSTRACT

Provided are various systems, methods, and programs embodied in a computer readable medium for estimating a guarantee time. In one embodiment, a method is provided that comprises the steps of estimating at least one strip guarantee component time, determining a bounding of the guarantee time from the at least one strip guarantee component time, and calculating an estimate of the guarantee time.

### BACKGROUND

To print a page on a laser printer or other type of printer, many different operations occur during the initiation of the printing of the page including the processing of the page into a form compatible with the printer as well as warming up of the printer itself. For example, before the initiation of a print operation, a page is often expressed in a page description language. Such a page is often received by a printer and converted into an intermediate form by a composing or interpreting operation. Such an operation may “stripify” the page by separating the content contained therein into a number of strips for individual rendering and other processing. Thereafter, the strips of such a page undergo a “guarantee” process, for example, in which they are rendered into scan bits, compressed, and are optionally stored to a disk. Once the entire page is guaranteed, the printer is “spun-up” which refers to warming up of all idle components as necessary, etc., in preparation for printing. Thereafter, the page is printed. Unfortunately, the entire process of spinning up a printer can take several seconds, thereby presenting a significant print delay that translates into wasted time and efficiency.

### SUMMARY

The present invention provides for various systems, methods, and programs embodied in a computer readable medium for estimating a guarantee time for a page to be printed on a printer. In one embodiment, a method is provided that comprises the steps of estimating at least one strip guarantee component time, determining a bounding of the guarantee time from the at least one strip guarantee component time, and calculating an estimate of the guarantee time.

### BRIEF DESCRIPTION OF THE DRAWINGS

The invention can be understood with reference to the following drawings. The components in the drawings are not necessarily to scale. Also, in the drawings, like reference numerals designate corresponding parts throughout the several views.

FIGS. 1A and 1B are timing diagrams of the initiation of print operations according to embodiments of the present invention;

FIG. 2 is a drawing of an exemplary page that is stripified by the composition that is part of initiation of a print operation as described in the timing diagrams of FIGS. 1A and 1B;

FIGS. 3A-3D are timing diagrams of various guarantee operations that may be performed as shown in the timing diagrams of FIGS. 1A and 1B according to an embodiment of the present invention;

FIG. 4 is an exemplary block diagram of a printer that initiates printing operations according to the timing diagrams of FIGS. 1A and/or 1B;

FIGS. 5A and 5B are exemplary flow charts that illustrate two embodiments of a spin-up initiator executed in the printer of FIG. 4;

FIG. 6 is a flow chart that provides a first example of logic, code, or steps implemented in the printer of FIG. 4 to estimate a guarantee time of a page to be printed; and

FIG. 7 is a flow chart that provides a second example of logic, code, or steps implemented in the printer of FIG. 4 to estimate a guarantee time of a page to be printed.

### DETAILED DESCRIPTION

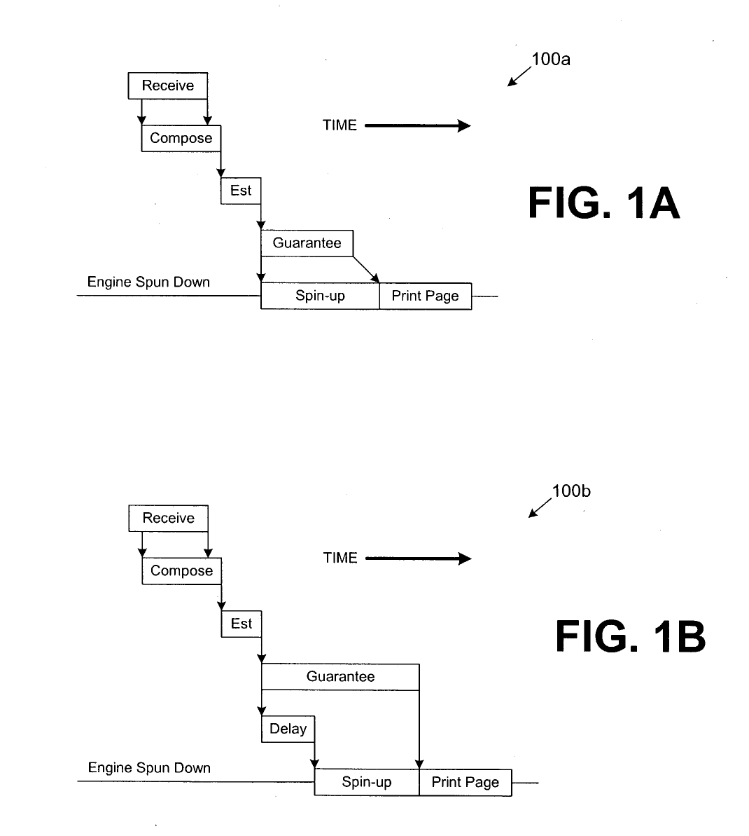

Referring to FIG. 1A, shown is a timing diagram 100a of an initiation of a print operation according to an embodiment of the present invention. Assuming that a page is to be printed on a printer such as, for example, a laser printer, the print operation is initiated by receiving the page to be printed in the printer from a remote device such as a computer system, etc. In this regard, the page is received when the data embodying the page is communicated to the printer and stored in a memory associated with the printer. At this stage, the page may be expressed in a page description language such as Printer Control Language (PCL), Postscript, or other language. It is understood that while the discussion herein refers to the printing of a single page, the same applies to the printing of a multiple page document, etc. At this time, the printer upon which the page is to be printed is “spun-down” as indicated.

Before the entire page has been received, the printer initiates composing/interpreting of portions of the page that have already been received. The composing of the page entails translating the page embodied in the page description language to an intermediate form. The intermediate form is stripified in that it partitions the page into a number of strips to implement guarantee functions as will be described. Once the composing of the page is complete, then an estimation of a guarantee time is determined. The guarantee time is the period of time that it takes to perform a guarantee of the page. Specifically, a guarantee operation may comprise one or more component operations that are performed to ready a page for printing. These component operations may be, for example, a rendering operation, a compression operation, and/or a masering operation. The rendering operation, compression operation, and masering operations are performed, for example, on a strip by strip basis. The rendering operation entails rendering the page into raster bits that are provided to a print engine within the printer for the printing of the page. In addition, the compression operation entails compressing the data that embodies the raster bits so as to take up a reduced amount of memory such as disk space, etc. In some printers or other peripheral devices, the compression operation is not performed. The masering operation entails storing the page on a disk or other memory component, etc. The masering may be done, for example, so that previously rendered pages can be reprinted in situations where users wish to print multiple collated copies of a multiple page document. However, there are circumstances where the masering operation need not be performed such as, for example, when only a single copy of a document is to be printed.

Once an estimate of the guarantee time is obtained, then a determination is made as to whether the guarantee time is greater than a spin-up time of the printer. In this regard, the printer includes a spin-up procedure in which all components of a print engine in the printer are warmed up and placed in an operational state for printing the page as can be appreciated by those with ordinary skill in the art. The spin-up time is the period of time it takes to perform the spin-up procedure and can last, for example, for about 5 to 10 seconds or other time as is appropriate. As depicted in the timing diagram 100a, if the guarantee time is less than the spin-up time, then the guaranteeing of the page is commenced at substantially the same time as the spin-up procedure. In this regard, the spin-up of the printer is performed concurrently with the guaranteeing of the page to be printed thereon. Once the page has been guaranteed and the printer has finished spinning-up, the printing of the page is commenced as shown.

A particular benefit of the initiation of the print operation as depicted by the timing diagram 100a is that the concurrent guaranteeing of the page and the spinning-up of the printer reduces the total amount of time it takes to initiate the printing of the page. Specifically, since the guaranteeing of the page is performed concurrently with the spin-up of the printer, less time is consumed than would be the case if the guarantee and the spin-up functions were performed consecutively.

In order to be able to perform the guaranteeing of the page and the spin-up of the printer concurrently, the estimation of the guarantee time is obtained. This is because it is preferable that the guarantee process is complete and that the page ready for printing upon the completion of the spin-up of a print engine within a printer. Specifically, the spin-up process places the print engine in the printer in a state that facilitates printing of one or more pages. This includes, for example, heating various components in the printer as well as other performing other functions as can be appreciated by those with ordinary skill in the art. It is often the case that it is not desirable for a print engine to remain “spun-up” for very long without commencing a print operation as significant degradation of components within the print engine may otherwise result. Also, in the spun-up state, it is the typical case that the power consumption of a print engine is much higher than in the spun down state.

As a consequence, it is preferable that the guaranteeing of the page be complete by the time the spin-up of a printer is complete so that printing can commence as soon as possible thereafter. While it may be preferable that the printing commence immediately after the spin-up of a printer is complete, it is understood that the printing of a document may commence at any time while the printer is in the “spun-up” state. However, it is understood that the printer remains “spun-up” for a predefined period of time. Consequently, there is ultimately a maximum time that the printer will wait for printing to commence after the printer has spun-up before the printer will spin down. If this were to occur, then the printer would wait for the spin down process to complete and then the print engine would be spun-up once more to print a page. Obviously, such a scenario would add several seconds to the wait for a page to be printed.

The guarantee time can vary from page to page, depending upon the content of the pages. In some cases, the guarantee time of a particular page may be much greater than a spin-up time of the printer upon which the page is to be printed. For other pages, the guarantee time may be less than or equal to the spin-up time of the printer. The discussion with reference to the timing diagram 100a above illustrates the situation where the guarantee time is less than the spin-up time. Specifically, the guaranteeing of a page can be initiated at substantially the same time as the spin-up of the print engine in the printer since it is known that the guaranteeing of the page will be completed at the time that the print engine is finished spinning-up and is ready to print. In such case, the print engine will not wait in the spun-up state for the guaranteeing of the page to be completed. Consequently, the total time it takes to initiate the printing of the page is correspondingly reduced due to the concurrent guaranteeing and spin-up operations. However, for pages in which the guarantee time is greater than the spin-up time, a different approach is described herein since the guaranteeing of such pages would not be completed before the spin-up of the print engine is complete if both functions were initiated at substantially the same time.

With reference to FIG. 1B, shown is a timing diagram 100b that illustrates the initiation of a print operation in a scenario where the guarantee time is greater than the spin-up time. In the beginning, the page is received by the printer and is composed in a similar manner as was discussed with reference to the timing diagram 100a (FIG. 1A). After the page is composed, the estimate of the guarantee time is determined. As shown in the timing diagram 100b, the guarantee time is greater than the spin-up time. Once the estimate of the guarantee time is obtained, then a delay is calculated which is substantially equal to the guarantee time minus the spin-up time. Thereafter, the guaranteeing of the page and the delay are initiated at substantially the same time. Once the delay has ended, then the spin-up of the print engine in the printer is commenced. Given that the delay plus the spin-up time is approximately equal to the guarantee time, then the guaranteeing of the page is complete at approximately the same time that the print engine has completed the spin-up process. Thereafter, the page is printed.

Thus, by estimating the guarantee time, the delay can be calculated that is imposed before spinning-up the print engine while the guaranteeing of the page is performed. Consequently, the total time it takes to initiate a printing of a page does not include waiting for the time that it takes the print engine of the printer to spin-up.

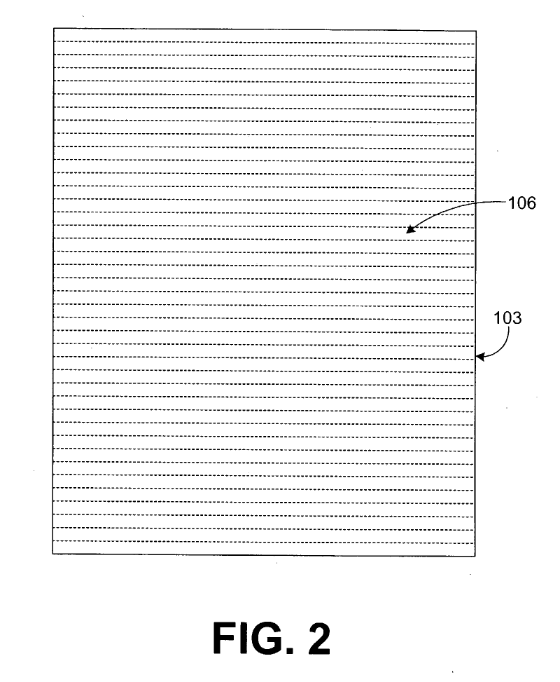

Referring next to FIG. 2, shown is an example of a page 103 in the intermediate state during the initiation of a print operation as discussed above. The page 103 has been stripified in that it has been partitioned into a number of strips 106. During the guarantee process, each of the strips 106 is guaranteed independently, for example, as can be appreciated by those with ordinary skill in the art. Among other reasons, this is done, for example, to reduce the amount of memory used to temporarily store the raster bits that are generated during the guarantee process, etc.

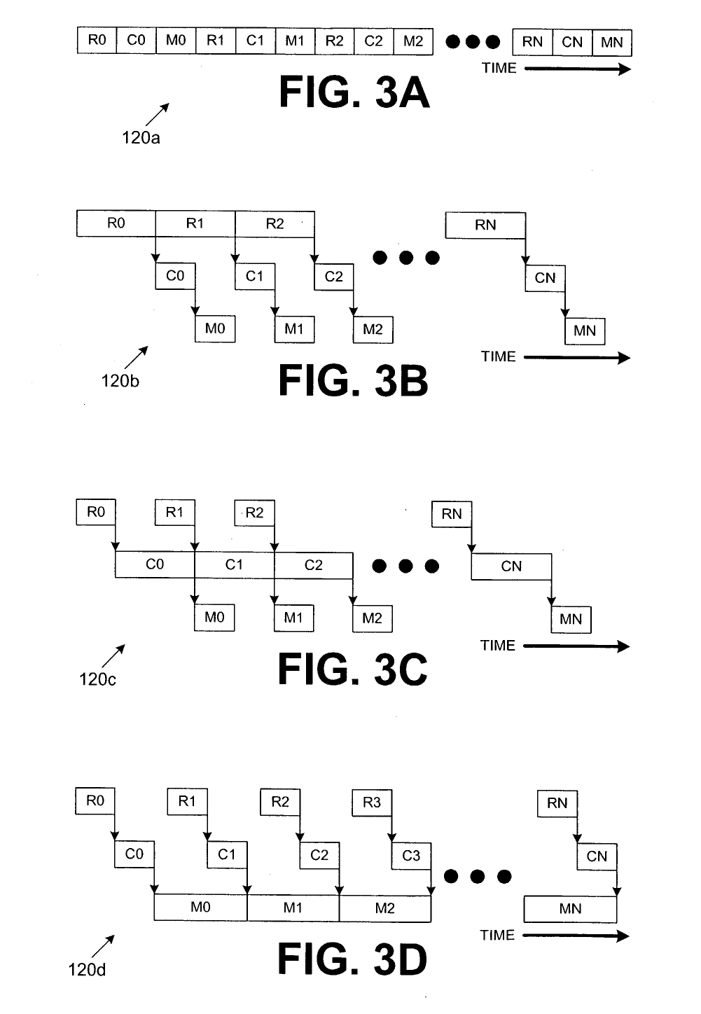

With reference to FIGS. 3A-3D, shown are a number of timing diagrams 120a-d that illustrate both single threaded and multiple threaded guarantee operations according to various embodiments of the present invention. As previously stated, a guarantee operation typically includes one or more component operations such as rendering operations, compression operations (if any), and masering operations (if any). Assuming that a respective page has been partitioned into strips 106 (FIG. 2), then to guarantee the entire page, a guarantee operation is performed for each of the strips 106. Correspondingly, this means that a render operation, compression operation (if any), and an optional masering operation (if any) is performed for each of the strips 106. A guarantee operation may be either single threaded or multiple threaded, depending upon the capabilities of the respective printer. A printer that performs single threaded or serial guarantee operations can only perform one of a render, compression, or masering operation at a time. The printer that performs multiple threaded guarantee operations can perform render, compression, and masering operations in parallel.

The timing diagram 120a shows a single threaded or serial guarantee operation. In this respect, the render operations R0-N, compression operations C0-N, and masering operations M0-N are each performed serially, where the total guarantee time a respective page equals the cumulative total of all of the time necessary to perform the render operations R0-N, compression operations C0-N, and masering operations M0-N. The timing diagrams 120b-d each show a multiple threaded guarantee operation in which render operations R0-N, compression operations C0-N, and masering operations M0-N are performed in parallel as shown. The multiple threaded guarantee operations depicted in the timing diagrams 120b-d are “bound” to either the rendering, compression, or masering operations associated with each of the strips 106. In this respect, the multiple threaded guarantee operations are thus characterized as “render bound”, “compression bound”, or “masering bound”.

A guarantee operation is designated as render bound, compression bound, or masering bound depending upon which of the rendering operations R0-N, compression operations C0-N, or masering operations M0-N is the longest. The timing diagram 120b illustrates a render bound compression operation that includes render times of the render operations R0-N for each of the strips 106 that are longer than the corresponding compression and masering times. Similarly, the timing diagrams 120c and 120d illustrate compression bound and masering bound guarantee operations. Whether or not a guarantee operation for a respective page is render bound, compression bound, are masering bound determines how the estimate of the total guarantee time a respective page is calculated as will be discussed. In addition, given that compression operations and/or masering operations may not be performed for a specific guarantee operation, then such component operations can be deleted from the timing diagrams 120a-c.

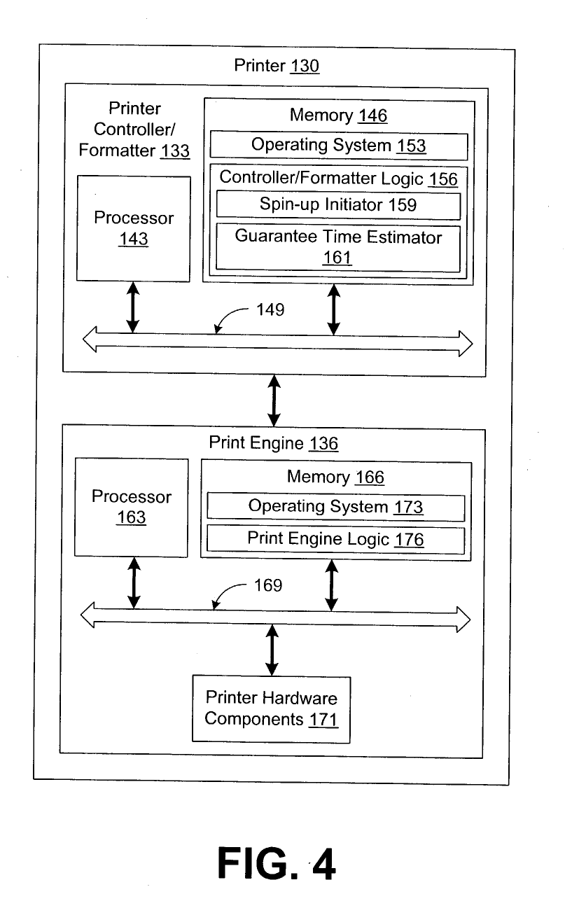

Turning then, to FIG. 4, shown is a block diagram of a printer 130 according to an embodiment of the present invention. In this respect, the printer 130 maybe, for example, a laser printer, ink jet printer, or other device with like capability. Alternatively, the printer may reside within a multi-function peripheral such as a device that combines printing functionality with scanning, copying, faxing, and other functionality. The printer 130 includes a printer controller/formatter 133 and the print engine 136.

The printer controller/formatter 133 includes a processor circuit having a processor 143 in the memory 146, both of which are coupled to a local interface 149. In this respect, the local interface 149 may be, for example, a data bus with an accompanying control/address bus as can be appreciated by those with ordinary skill in the art. Stored in the memory 146 and executable by the processor 143 are an operating system 153 and controller/formatter logic 156. The controller/formatter logic 156 is responsible for performing all receiving, composing, and guaranteeing operations within the printer 130 as well as other operations as can be appreciated by those with ordinary skill in the art. The controller/formatter logic 156 includes a spin-up initiator 159 and a guarantee time estimator 161. The spin-up initiator 159 and the guarantee time estimator 161 are executed by the processor 143 to estimate guarantee times and to cause the concurrent implementation of a guarantee operation and a spin-up of the printed engine 136 as was discussed above.

The print engine 136 also includes a processor circuit having a processor 163 and a memory 166, both of which are coupled to a local interface 169. The local interface 169 may be, for example, a data bus with accompanying control/address bus as can be appreciated by those with ordinary skill in the art. The print engine 136 also includes one more printer hardware components 171 that are operatively coupled to the local interface 169 such as, for example, paper moving mechanisms, lasers, rotating polygonal mirrors, print heads, and other hardware as can be appreciated by those with ordinary skill in the art.

Stored in the memory 166 and executable by the processor 163 are an operating system 173 and print engine logic 176. The print engine logic 176 is executable by the processor 163 to control the operation of the printer hardware components 171. In this respect, the print engine logic 176 implements the spin-up of the print engine 136 as can be appreciated by those with ordinary skill in the art.

The memories 146 and 166 are defined herein as both volatile and nonvolatile memory and data storage components. Volatile components are those that do not retain data values upon loss of power. Nonvolatile components are those that retain data upon a loss of power. Thus, the memories 146 and 166 may comprise, for example, random access memory (RAM), read-only memory (ROM), hard disk drives, floppy disks accessed via an associated floppy disk drive, compact discs accessed via a compact disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device. To facilitate masering operations, for example, the memory 146 includes a hard disk drive or other memory device.

Also, each of the processors 143 and 163 may represent multiple processors and each of the memories 146 and 166 may represent multiple memories that operate in parallel processing circuits, respectively. In such a case, each of the local interfaces 149 and 169 may be an appropriate network that facilitates communication between any two of the multiple processors, between any processor and any of the memories, or between any two of the memories, etc.

In addition, the operating systems 153 and 173 are executed to control the allocation and usage of hardware resources in their respective processor circuits such as the allocation of memory, processing time and peripheral devices, etc. In this manner, the operating systems 153 and 173 serve as the foundation on which applications depend as is generally known by those with ordinary skill in the art.

While the printer 130 is described herein as including both a printer controller/formatter 133 and a print engine 136 that are implemented using separate processor circuits, it is understood that the functionality of both components may be implemented using an alternative architecture that employs a single processor circuit or other combinations of processor circuits and other circuits, etc.

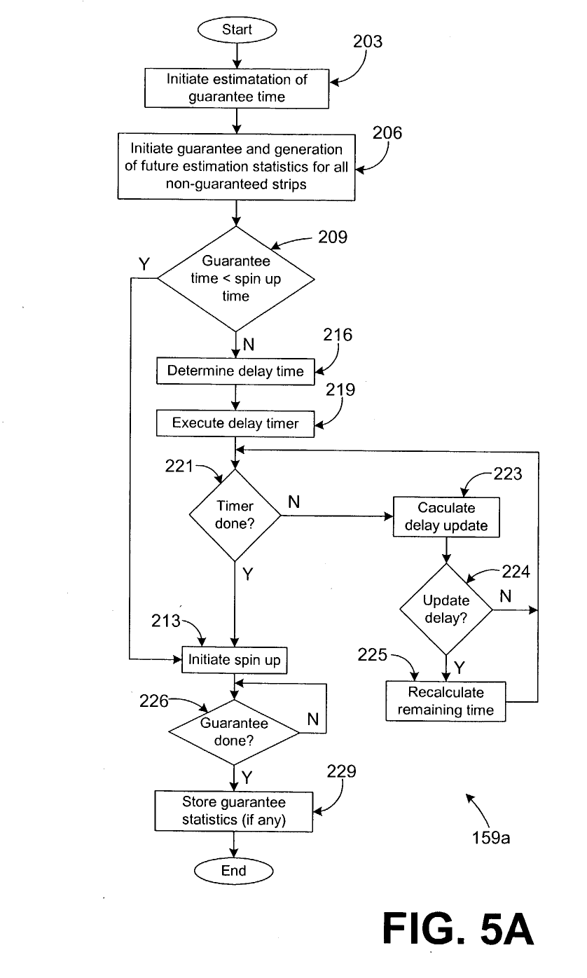

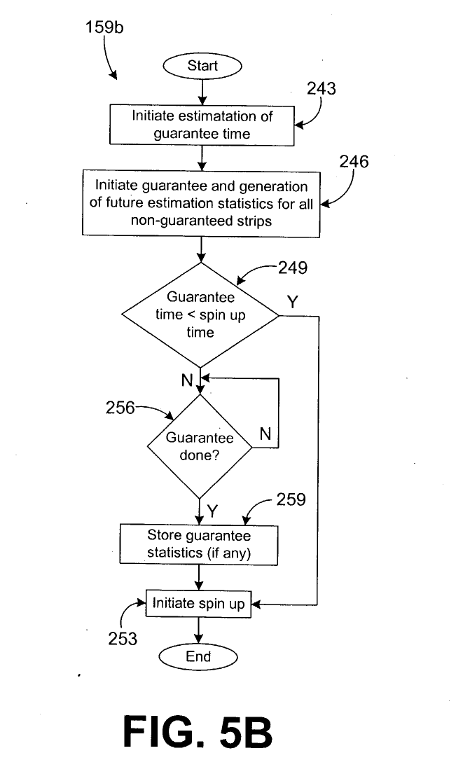

With reference to FIG. 5A, shown is an exemplary flowchart of the spin-up initiator 159 denoted herein as 159a according to an embodiment of the present invention. Alternatively, the flowchart of FIG. 5A may be viewed as depicting steps of a method implemented in the printer 130 to provide for the concurrent performance of a guarantee operation and spin-up of the print engine 136 (FIG. 4).

Beginning with box 203, the spin-up initiator 159a executes the guarantee time estimator 161, thereby obtaining an estimate of the guarantee time that is associated with the page to be printed. In this respect, it is assumed that the page has been received and composed/interpreted, etc. Once the estimate of the guarantee time is obtained, the spin-up initiator of 159a proceeds to box 206 in which the guaranteeing of the page is initiated. In addition, statistics relative to the guarantee operation being performed are generated. The statistics may include, for example, actual render times, compression times (if any), and masering times (if any) for strips that are guaranteed, etc. Such statistics may be employed for future estimation operations as will be described.

Thereafter, in box 209 the spin-up initiator 159a determines whether the guarantee time estimated in box 203 is less than or equal to the spin-up time of the print engine 136. In this respect, the spin-up time of the printer engine 136 may be predetermined based on empirical data or may be provided in technical specifications that accompany the print engine 136. If the guarantee time is less than the spin-up time in box 209, then the spin-up initiator 159a proceeds to box 213 in which the spin-up of the print engine 136 is initiated. Otherwise, the spin-up initiator 159a proceeds to box 216 in which a delay time is determined that is to be used to delay the initiation of the spin-up of the print engine 136. The delay time may be calculated, for example, by subtracting the spin-up time from the guarantee time.

Once the delay is calculated in box 216, then the spin-up initiator 159a proceeds to box 219 in which a delay timer set to last for the delay determined in box 216 is executed. Thereafter, in box 221 the spin-up initiator 159a determines if the delay has tolled such that the delay timer has completed its operation. If such is the case, then the spin-up initiator 159a proceeds to box 213 to initiate the spin-up of the print engine 136. If not, then the spin-up initiator 159a proceeds to box 223 in which an update to the delay is calculated based upon the guarantee statistics that have been harvested during the current guarantee operation as well as during other guarantee operations. The update may be, for example, an amount of time by which the delay is to be reduced or extended. Thereafter, in box 224 the spin-up initiator 159a determines whether the update is to be applied to the current delay. For example, if the delay update would alter the current delay by a negligible amount, then the update may be disregarded. If the update is to be applied, then the spin-up initiator 159a proceeds to box 225. Otherwise, the spin-up initiator 159a reverts back to box 221. In box 225, the spin-up initiator 159a recalculates the remaining time in the time delay. In this regard, the remaining time may be reduced or extended as is appropriate. Thereafter, the spin-up initiator 159a reverts back to box 221.

In this respect, the spin-up of the print engine 136 delayed when the guarantee time is greater than the spin-up time. Otherwise, the spin-up of the print engine 136 begins immediately. In either case, the spin-up of the print engine 136 occurs concurrently with the guarantee operation. Also, if a delay is imposed, then the spin-up initiator 159a updates the delay as information about the guarantee operation relative to the current page is obtained.

Once the spin-up of the print engine 136 has been initiated in box 213, then the spin-up initiator 159a proceeds to box 226 to wait for the guarantee operation of the page in question to be completed. If the guarantee operation takes much longer to complete than was estimated and the print engine times out in the spun-up state, then a spin down of the print engine is initiated. In such case, the print engine will spin-up when the guarantee operation has finished. Assuming that the guarantee operation has completed in box 226, then the spin-up initiator 159a proceeds to box 229 to store any future estimation statistics obtained from the guarantee operation that may be employed in estimating future guarantee times. Thereafter, the spin-up initiator 159a ends as shown.

Referring next to FIG. 5B, shown is an exemplary flowchart of a second version of the spin-up initiator 159b according to an embodiment of the present invention. Alternatively, the flowchart of FIG. 5B may be viewed as depicting steps of a method implemented in the printer 130 to provide for the concurrent performance of a guarantee operation and spin-up of the print engine 136 (FIG. 4).

Beginning with box 243, the spin-up initiator 159b estimates a guarantee time associated with the current page to be printed. Such a page will have undergone the composing operation as was described above. Thereafter, in box 246 the guarantee operation is initiated with respect to the page. Also, the concurrent generation of all future estimation statistics associated with the guarantee operation is initiated. Thereafter, in box 249 the spin-up initiator 159b determines whether the guarantee time estimated in box 243 is less than or equal to the spin-up time of the print engine 136. If so, then the spin-up initiator 159b proceeds to box 253 in which the spin-up of the print engine 136 is initiated. Thereafter, the spin-up initiator 159b ends as shown.

If in box 249 the guarantee time is greater than the spin-up time of the print engine 136, then the spin-up initiator 159b proceeds to box 256 to wait until the guarantee operation initiated in box 246 has completed. Thereafter, the spin-up initiator 159b proceeds to box 259 in which all future estimations statistics generated during the guarantee operation that may be employed in the estimation of future guarantee times are stored in a memory. Then, the spin-up initiator 159b proceeds to box 253 in which the spin-up of the print engine 136 is initiated. Thus, the spin-up initiator 159b causes the concurrent performance of the spin-up of the print engine 136 and a guarantee operation only when the guarantee time is less than equal to the spin-up time. In this respect, the spin-up initiator 159b may be employed in circumstances where accurate estimation of guarantee times can be difficult to achieve. In this respect, the accurate calculation of a delay is avoided and the print engine 136 waits in a spun-up state before beginning printing for a smaller period of time than without concurrent performance of the spin-up of the print engine 136 and the guarantee operation.

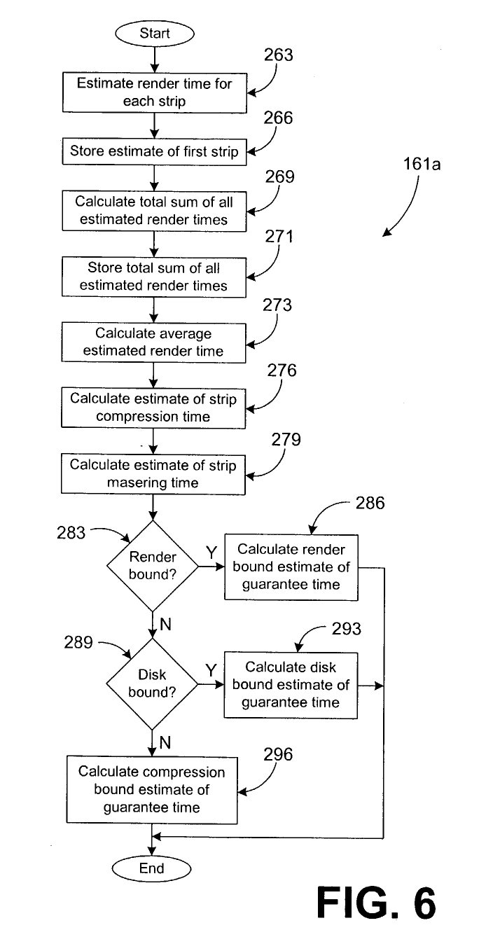

With reference to FIG. 6, shown is an exemplary flowchart of a first embodiment of the guarantee time estimator 161 (FIG. 4) denoted herein as guarantee time estimator 161a according to an embodiment of the present invention. Alternatively, the flowchart of FIG. 6 may be viewed as depicting steps of a method implemented in the printer 130 (FIG. 4) to estimate guarantee time for a page to be printed.

Beginning with box 263, the guarantee time estimator 161a performs an estimation of the render time for each strip 106 (FIG. 2) on the page 103 (FIG. 2) to be printed. For each strip, this may be done, for example, by using the following equation:

$$StripRenderTime = {\sum }_{i = 1}^{ObjectTypes} ( NumberofObjectsofTypeOnstrip \times ExpectedRenderTimeperObjectType )$$

The expected render time per object type can be determined empirically, for example, by studying a variety of object types and obtaining average render times and other relevant data for each such object type. The objects may be, for example, circles, lines, squares, or other shapes and/or characters, etc. The number of objects of a type on a strip is the number of objects of a specific type that appears in a strip to be rendered. For additional discussion on the estimation of the render times, reference is made to U.S. Pat. No. 5,129,049 issued to Cuzzo et al., which is incorporated herein in its entirety.

Thereafter, in box 266 the estimate of the first strip 106 is stored in a predetermined location of a memory for potential future use. Thereafter, in box 269 the guarantee time estimator calculates the sum of all of the estimated strip render times for all of the strips 106 on the page 103. Then, in box 271 the sum of all of the estimated strip render times is stored in a predetermined location in a memory for potential future use. Thereafter, in box 273, an average estimated strip render time is calculated by dividing the sum of all of the estimated strip render times by the total number of strips on the page 103.

Alternatively, rather than performing the procedure outlined in boxes 263-273, an average estimated strip rendering time may be obtained by estimating the strip rendering time for a subset of the total number of strips 106 on the page. An average estimated strip rendering time may be calculated from the subset of the total number of strips 106. In this regard, the first estimated strip rendering time and the sum of all of the estimated strip rendering times is not stored in memory. In any event, an average is employed, for example, so as to account for the fact that rendering times may vary from strip to strip.

Next, in box 276, an estimate of a strip compression time is calculated for the current page to be guaranteed. The estimate of the strip compression time may be calculated, for example, using the following equation:

StripCompressionTime=(SetupTime)+(InputRateCoefficient×UncompressedStripSize)+(OutputRateCoefficient×CompressedStripSize)

where the Setup Time is the time it takes for the compressor to become operational, the Input Rate Coefficient of the compressor is the rate of data input by the compressor, the Uncompressed Strip Size of the strip 106 (FIG. 2) in Megabytes, the Output Rate Coefficient is the rate of data output by the compressor, and the Compressed Strip Size is the size of the strip after compression is complete. The set-up time, input rate coefficient, and the output rate coefficient may be determined by developing an analytical model of the compressor or by obtaining such information empirically during guarantee operations performed over a diverse set of print jobs. The uncompressed size of the strip 106 can be ascertained from the uncompressed strip 106. The Compressed Strip Size may be determined by dividing the uncompressed strip size by an appropriate compression ratio. The compression ratio may be determined empirically by collecting statistics during guarantee operations performed over a diverse set of print jobs. Alternatively, the compression ratio may be determined dynamically by collecting and maintaining statistics of a current print job including the currently-compressed strips of a page as it undergoes a guarantee operation.

In addition, if no compression operation is performed, then box 276 may be bypassed or a strip compression time of zero may be assumed.

Then, in box 279, an estimate of a strip masering time is calculated for the current page to be guaranteed. It is understood that in some situations the masering of rendered strips of a document is not performed. Such may be the case, for example, if a single copy of a document is printed by the printer 130 (FIG. 4) as opposed to multiple copies of a multi page, collated document. The estimate of the strip masering time may be calculated, for example, using the following equation:

StripMaseringTime=SetupTime+(DiskTransferRate×CompressedStripSize)

where the Set-up time and the Disk Transfer Rate are parameters associated with the disk drive in question and can be obtained from the manufacturer thereof or can be determined empirically. The Compressed Strip Size may be determined as described above. In addition, if no masering is performed, then box 279 may be bypassed or a strip masering time of zero may be assumed. Thereafter, in box 283, the guarantee time estimator 161a determines whether the guarantee operation is render bound in that the render time is greater than the compression and masering times. If so, then the guarantee time estimator 161a proceeds to box 286 to calculate a render bound estimate of the guarantee time. In this respect, the estimate of the guarantee time may be calculated, for example, as:

GuaranteeTime=SumOfAllStripRenderTimes+LastStripCompressionTime+LastStripMaseringTime+SetupTimes+CloseTimes

where the last strip compression time and the last strip mastering time are the estimated times it takes to compress and maser the last strip of the page. Also, the set-up times may be, for example, the times needed to set up and launch individual threads, for example, and the times that it takes to perform other set up tasks. The close times may be, for example, those times it takes to synchronize the completion and closing of concurrent threads, etc. Once the guarantee time is calculated in box 286, then the guarantee time estimator 161a ends as shown.

However, if the guarantee operation is not render bound as determined in box 283, then the guarantee time estimator 161a proceeds to box 289. In box 289 the guarantee time estimator 161a determines whether the guarantee operation is masering bound. If so, then the guarantee time estimator 161a proceeds to box 293. Otherwise, the guarantee time estimator 161a moves to box 296.

In box 293 the guarantee time estimator 161a calculates the maser bound estimate of the guarantee time for the current page. In this respect, the maser bound estimate of the guarantee time may be calculated, for example, using the following equation:

GuaranteeTime=SumOfAllMaseringTimes+FirstStripRenderTime+FirstStripCompressionTime+SetupTimes+CloseTimes

where the first strip render time and the first strip compression time are the estimated times it takes to compress and maser the first strip of the page. Thereafter, the guarantee time estimator 161a ends as shown.

Assuming that the guarantee time estimator 161a proceeded to box 296, then the guarantee time estimator 161a calculates a compression bound estimate of the guarantee time for the current page. In this respect, the compression bound estimate of the guarantee time may be calculated, for example, using the following equation:

GuaranteeTime=SumOfAllStripCompressionTimes+FirstStripRenderTime+LastStripMaseringTime+SetupTimes+CloseTimes

where the first strip render time is the estimated time it takes to render the first strip of the page, and, the last strip masering time is the estimated time it takes to maser the last strip of the page. Thereafter, the guarantee time estimator 161a ends as shown.

In addition, assuming that a compression operation or masering operation are not actually performed in a particular guarantee operation, then a value of zero for the strip compression time and/or strip masering times may be employed in determining whether a respective guarantee operation is render bound, compression bound, or masering bound, and to calculate the estimate of the guarantee time of a page. As an alternative, boxes 283-296 may be replaced by a calculation of the guarantee time using a single threaded or serial guarantee operation as was described in the timing diagram 120a (FIG. 3A). In such case, the guarantee time may be calculated, for example, as follows:

GuaranteeTime=SumOfAllStripRenderTimes+SumOfAllStripCompressionTimes+SumOfAllStripMaseringTimes+SetupTimes+CloseTimes

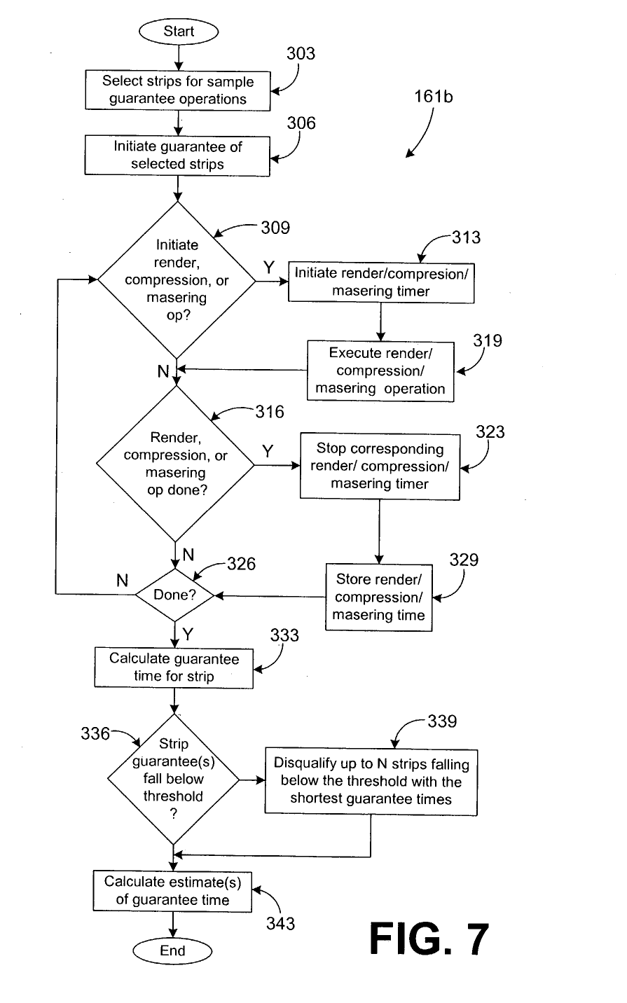

Turning next to FIG. 7, shown is an exemplary flow chart of a second embodiment of the guarantee time estimator 161 (FIG. 4) denoted herein as guarantee time estimator 161b according to an embodiment of the present invention. Alternatively, the flow chart of FIG. 7 may be viewed as depicting steps of a method implemented in the printer to estimate the guarantee time associated with the printing of a page to be printed.

Beginning with box 303, the guarantee time estimator 161b selects strips 106 (FIG. 2) with which sample guarantee operations are performed. Given that a predefined number of strips 106 may exist on a page 103 (FIG. 2), the precise strips may be chosen, for example, using the following equations:

FirstSelectedStrip=1×(TotalStripsOnPage/(NumberOfSampledStrips+1));

SecondSelectedStrip=2×(TotalStripsOnPage/(NumberOfSampledStrips+1));

ThirdSelectedStrip=3×(TotalStripsOnPage/(NumberOfSampledStrips+1))

LastSelectedStrip=TotalNumberOfSelectedStrips×(TotalStripsOnPage/(NumberOfSampledStrips+1))

Alternatively, the strips 106 may be chosen randomly or using some other method. The total number of selected strips 106 may be, for example, from 3 to 5 strips 106. However, it is understood that any number of strips 106 may be selected keeping in mind that if the total number of selected strips 106 is too large, it may take a significant amount of time to perform the estimation of the guarantee time, thereby substantially reducing the benefit obtained by the concurrent performance of the spin-up and guarantee functions as described above.

In addition, the approach employed to select the strips 106 for the sample guarantee operations should avoid selecting strips that lie at or near the very top and bottom of the page since such strips typically fall in margins that do not include printed content. This is because such strips would provide unusually short guarantee times which would result in significant inaccuracies in the guarantee time estimate for the entire page as will be described.

Once the strips have been selected in box 303, the guarantee time estimator 161b proceeds to box 306 in which the guarantee of the selected strips is initiated. Thereafter, in box 309, if a render operation, compression operation (if any), or masering operation (if any) is to be performed in accordance with the guaranteeing of the page, then the guarantee time estimator 161b proceeds to box 313. Otherwise the guarantee time estimator 161b moves to box 316. In box 313 the guarantee time estimator 161b initiates a timer that tracks the period of time necessary to perform the respective render operation, compression operation, or masering operation. Thereafter, in box 319 the corresponding render operation, compression operation, or masering operation is executed. The guarantee time estimator 161b then proceeds to box 316.

In box 316 the guarantee time estimator 161b determines whether a render operation, compression operation, or masering operation has completed. If so, then the guarantee time estimator 161b proceeds to box 323. Otherwise, the guarantee time estimator 161b proceeds to box 326. In box 323 the timer corresponding to the respective completed render operation, compression operation, or masering operation is stopped. Then in box 329 the render/compression/masering time is stored in a memory to be used in estimating the total guarantee time for the respective strip 106. In this manner, estimates of all render times, compression times, and masering times associated with the strips selected in box 303 are obtained.

After the render/compression/masering time is stored in box 329, then the guarantee time estimator 161b proceeds to box 326 to determine if the guaranteeing of all of the strips 106 selected in box 303 is complete. If not, then the guarantee time estimator 161b reverts back to box 309. Otherwise, the guarantee time estimator 161b proceeds to box 333 in which the guarantee time is calculated for each selected strip 106 from the corresponding render, compression, and masering times. This may be done, for example, by adding the render, compression, and masering times corresponding to each respective strip 106, respectively. Thereafter, in box 336 the guarantee time estimator 161b determines whether any of the guarantee times estimated for each of the strips 106 in box 333 fall below a predefined threshold. The predefined threshold provides a minimum strip guarantee time that is used to ensure that the estimate of the guarantee time for the entire page is not under estimated due to the chance selection of a blank strip on a page in box 303.

If any of the strip guarantee times fall below the predefined threshold in box 336, then the guarantee time estimator 161b proceeds to box 339. Otherwise, the guarantee time estimator 161b moves to box 343. In box 339, any of the strips that have a strip guarantee time that falls below the predefined threshold are disqualified from consideration of the guarantee time of the page up to a maximum number N of disqualified strips. That is to say, that a maximum number N of the sampled strips 106 selected in box 303 are disqualified, thereby ensuring a minimum number of strips that are employed to estimate the guarantee time of the total page. The strips 106 that are disqualified are those with the lowest strip guarantee times. Once any strips 106 are disqualified in box 339, then the guarantee time estimator 161b proceeds to box 343 in which the estimate of the guarantee time of the current page is calculated. This may be done, for example, by calculating an average strip guarantee time from those strip guarantee times that were not disqualified in box 339. The guarantee time of the page 103 may be calculated by multiplying the number of strips 106 in the page 103 by the average strip guarantee time. In addition, multiple estimates of the page guarantee time may be calculated rather than a single estimate. Specifically, a low estimate, high estimate, and an average estimate may be calculated from the strip guarantee times. Multiple estimates of the guarantee time of the page may then be employed to determine when the spin-up of the print engine 136 is initiated. Thereafter, the guarantee time estimator 161b ends as shown.

The accuracy of the guarantee times calculated by the guarantee time estimators 161a and 161b may vary from page to page due to approaches taken to obtain the underlying rendering times, compression times (if any), and masering times (if any) as described above. As a result, it may be the case that a guarantee operation performed on a page is completed earlier or later than was estimated. The completion of guarantee operations earlier than estimated is of little consequence since presumably the guarantee operation will ultimately be completed before the print engine 136 has completed spinning-up. However, if the completion of the guarantee operation occurs later than was estimated, it is possible that the print engine 136 will be forced to wait in a spun-up state for a short period of time until the guarantee operation is completed. The length of such a wait depends upon the accuracy of the estimate of the guarantee time.

Although the spin-up initiator 159 and guarantee time estimator(s) 161 are described as being embodied in software or code executed by general purpose hardware as discussed above, as an alternative they may also be embodied in dedicated hardware or a combination of software/general purpose hardware and dedicated hardware. If embodied in dedicated hardware, the spin-up initiator 159 and guarantee time estimator(s) 161 can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

In addition, the flow charts of FIGS. 5A, 5B, 6 and 7 show the architecture, functionality, and operation of an implementation of the spin-up initiator 159 and guarantee time estimator(s) 161. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flow charts of FIGS. 5A, 5B, 6 and 7 show a specific order of execution, it is understood that the order of execution may differ from that which is depicted. For example, the order of execution of two or more blocks may be scrambled relative to the order shown. Also, two or more blocks shown in succession in FIGS. 5A, 5B, 6 and 7 may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present invention.

Also, where the spin-up initiator 159 and guarantee time estimator(s) 161 comprise software or code, they can be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of this specification, a “computer-readable medium” can be any medium that can contain, store, or maintain the spin-up initiator 159 and guarantee time estimator(s) 161 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Although the invention is shown and described with respect to certain embodiments, it is obvious that equivalents and modifications will occur to others skilled in the art upon the reading and understanding of the specification. The present invention includes all such equivalents and modifications, and is limited only by the scope of the claims.

What is claimed is:

1. A method for estimating a guarantee time, comprising the steps of:
estimating at least one strip guarantee component time;
determining a bounding of the guarantee time from the at least one strip guarantee component time; and
calculating an estimate of the guarantee time.

2. The method of claim 1, wherein the step of estimating the at least one strip guarantee component time further comprises the step of estimating a strip render time.

3. The method of claim 1, wherein the step of estimating the at least one strip guarantee component time further comprises the step of estimating a strip compression time.

4. The method of claim 1, wherein the step of estimating the at least one strip guarantee component time further comprises the step of estimating a strip masering time.

5. The method of claim 2, wherein the step of estimating the strip render time further comprises the step of calculating an average estimated strip render time from an estimated strip render time of each of a number of strips in a page.

6. The method of claim 1, wherein the step of calculating an estimate of the guarantee time further comprises the step of calculating a render bound estimate of the guarantee time.

7. The method of claim 1, wherein the step of calculating an estimate of the guarantee time further comprises the step of calculating a compression bound estimate of the guarantee time.

8. The method of claim 1, wherein the step of calculating an estimate of the guarantee time further comprises the step of calculating a masering bound estimate of the guarantee time.

9. A method for estimating a guarantee time, comprising the steps of:
guaranteeing a sample number of strips in a page;
tracking a strip guarantee time for each one of the sample number of strips; and
calculating at least one estimate of the guarantee time from the strip guarantee times.

10. The method of claim 9, further comprising the step of selecting the sample number of strips from a total number of strips in the page.

11. The method of claim 9, wherein the step of tracking the strip guarantee time for each one of the sample number of strips further comprises the step of implementing a timer during a rendering of each of the sample number of strips.

12. The method of claim 9, wherein the step of tracking the strip guarantee time for each one of the sample number of strips further comprises the step of implementing a timer during a compression of each of the sample number of strips.

13. The method of claim 9, wherein the step of tracking the strip guarantee time for each one of the sample number of strips further comprises the step of implementing a timer during a masering of each of the sample number of strips.

14. The method of claim 9, wherein the step of calculating at least one estimate of the guarantee time from the strip guarantee times further comprises the step of calculating an average strip guarantee time from the strip guarantee times.

15. The method of claim 9, wherein the step of calculating at least one estimate of the guarantee time from the strip guarantee times further comprises the step of multiplying the average strip guarantee time from a number of strips in the page.

16. The method of claim 14, wherein the step of calculating at least one estimate of the guarantee time from the strip guarantee times further comprises the step of disqualifying at least one of the strip guarantee times from the calculation of the average strip guarantee time if the at least one of the strip guarantee times is less than a predefined threshold.

17. A program embodied in a computer readable medium for estimating a guarantee time, comprising:
code that estimates at least one strip guarantee component time;
code that determines a bounding of the guarantee time from the at least one strip guarantee component time; and
code that calculates an estimate of the guarantee time.

18. The program embodied in the computer readable medium of claim 17, wherein the code that estimates the at least one strip guarantee component time further comprises code that estimates a strip render time.

19. The program embodied in the computer readable medium of claim 17, wherein the code that estimates the at least one strip guarantee component time further comprises code that estimates a strip compression time.

20. The program embodied in the computer readable medium of claim 17, wherein the code that estimates the at least one strip guarantee component time further comprises code that estimates a strip masering time.

21. The program embodied in the computer readable medium of claim 18, wherein the code that estimates the strip render time further comprises code that calculates an average estimated strip render time from an estimated strip render time of each of a number of strips in a page.

22. The program embodied in the computer readable medium of claim 17, wherein the code that calculates an estimate of the guarantee time further comprises the code that calculates a render bound estimate of the guarantee time.

23. The program embodied in the computer readable medium of claim 17, wherein the code that calculates an estimate of the guarantee time further comprises the code that calculates a compression bound estimate of the guarantee time.

24. The program embodied in the computer readable medium of claim 17, wherein the code that calculates an estimate of the guarantee time further comprises the code that calculates a masering bound estimate of the guarantee time.

25. A program embodied in a computer readable medium for estimating a guarantee time, comprising:
code that guarantees a sample number of strips in a page;
code that tracks a strip guarantee time for each one of the sample number of strips; and
code that calculates at least one estimate of the guarantee time from the strip guarantee times.

26. The program embodied in the computer readable medium of claim 25, further comprising code that selects the sample number of strips from a total number of strips in the page.

27. The program embodied in the computer readable medium of claim 25, wherein the code that tracks the strip guarantee time for each one of the sample number of strips further comprises code that implements a timer during a rendering of each of the sample number of strips.

28. The program embodied in the computer readable medium of claim 25, wherein the code that tracks the strip guarantee time for each one of the sample number of strips further comprises code that implements a timer during a compression of each of the sample number of strips.

29. The program embodied in the computer readable medium of claim 25, wherein the code that tracks the strip guarantee time for each one of the sample number of strips further comprises code that implements a timer during a masering of each of the sample number of strips.

30. The program embodied in the computer readable medium of claim 25, wherein the code that calculates at least one estimate of the guarantee time from the strip guarantee times further comprises code that calculates an average strip guarantee time from the strip guarantee times.

31. The program embodied in the computer readable medium of claim 25, wherein the code that calculates at least one estimate of the guarantee time from the strip guarantee times further comprises code that multiplies the average strip guarantee time from a number of strips in the page.

32. The program embodied in the computer readable medium of claim 30, wherein the code that calculates the at least one estimate of the guarantee time from the strip guarantee times further comprises code that disqualifies at least one of the strip guarantee times from the calculation of the average strip guarantee time if the at least one of the strip guarantee times is less than a predefined threshold.

33. A system for estimating a guarantee time, comprising:
a processor circuit having a processor and a memory;
a guarantee time estimator stored in the memory and executable by the processor, the guarantee time estimator comprising:
logic that estimates at least one strip guarantee component time;
logic that determines a bounding of the guarantee time from the at least one strip guarantee component time; and
logic that calculates an estimate of the guarantee time.

34. The system of claim 33, wherein the logic that estimates the at least one strip guarantee component time further comprises logic that estimates a strip render time.

35. The system of claim 33, wherein the logic that estimates the at least one strip guarantee component time further comprises logic that estimates a strip compression time.

36. The system of claim 33, wherein the logic that estimates the at least one strip guarantee component time further comprises logic that estimates a strip masering time.

37. The system of claim 34, wherein the logic that estimates the strip render time further comprises logic that calculates an average estimated strip render time from an estimated strip render time of each of a number of strips in a page.

38. The system of claim 33, wherein the logic that calculates an estimate of the guarantee time further comprises the logic that calculates a render bound estimate of the guarantee time.

39. The system of claim 33, wherein the logic that calculates an estimate of the guarantee time further comprises the logic that calculates a compression bound estimate of the guarantee time.

40. The system of claim 33, wherein the logic that calculates an estimate of the guarantee time further comprises the logic that calculates a masering bound estimate of the guarantee time.

41. A system for estimating a guarantee time, comprising:
a processor circuit having a processor and a memory;
a guarantee time estimator stored in the memory and executable by the processor, the guarantee time estimator comprising:
logic that guarantees a sample number of strips in a page;
logic that tracks a strip guarantee time for each one of the sample number of strips; and
logic that calculates at least one estimate of the guarantee time from the strip guarantee times.

42. The system of claim 41, wherein the guarantee time estimator further comprises logic that selects the sample number of strips from a total number of strips in the page.

43. The system of claim 41, wherein the logic that tracks the strip guarantee time for each one of the sample number of strips further comprises logic that implements a timer during a rendering of each of the sample number of strips.

44. The system of claim 41, wherein the logic that tracks the strip guarantee time for each one of the sample number of strips further comprises logic that implements a timer during a compression of each of the sample number of strips.

45. The system of claim 41, wherein the logic that tracks the strip guarantee time for each one of the sample number of strips further comprises logic that implements a timer during a masering of each of the sample number of strips.

46. The system of claim 41, wherein the logic that calculates at least one estimate of the guarantee time from the strip guarantee times further comprises logic that calculates an average strip guarantee time from the strip guarantee times.

47. The system of claim 41, wherein the logic that calculates at least one estimate of the guarantee time from the strip guarantee times further comprises logic that multiplies the average strip guarantee time from a number of strips in the page.

48. The system of claim 46, wherein the logic that calculates the at least one estimate of the guarantee time from the strip guarantee times further comprises logic that disqualifies at least one of the strip guarantee times from the calculation of the average strip guarantee time if the at least one of the strip guarantee times is less than a predefined threshold.

49. A system for estimating a guarantee time for a page to be printed on a printer, comprising:
means for estimating at least one strip guarantee component time;
means for determining a bounding of the guarantee time from the at least one strip guarantee component time; and
means for calculating an estimate of the guarantee time.

50. The system of claim 49, wherein the means for estimating the at least one strip guarantee component time further comprises means for estimating a strip render time.

51. The system of claim 49, wherein the means for estimating the at least one strip guarantee component time further comprises means for estimating a strip compression time.

52. The system of claim 49, wherein the means for estimating the at least one strip guarantee component time further comprises means for estimating a strip masering time.

53. The system of claim 50, wherein the means for estimating the strip render time further comprises means for calculating an average estimated strip render time from an estimated strip render time of each of a number of strips in the page.

54. A system for estimating a guarantee time for a page to be printed on a printer, comprising:
means for guaranteeing a sample number of strips in the page;
means for tracking a strip guarantee time for each one of the sample number of strips; and
means for calculating at least one estimate of the guarantee time from the strip guarantee times.

55. The system of claim 54, wherein the means for tracking the strip guarantee time for each one of the sample number of strips further comprises means for implementing a timer during a rendering of each of the sample number of strips.

56. The system of claim 54, wherein the means for tracking the strip guarantee time for each one of the sample number of strips further comprises means for implementing a timer during a compression of each of the sample number of strips.

57. The system of claim 54, wherein the means for tracking the strip guarantee time for each one of the sample number of strips further comprises means for implementing a timer during a masering of each of the sample number of strips.
